(19) United States
(12) Patent Application Publication
(10) Pub. No.: US 2022/0341214 A1
(43) Pub. Date: Oct. 27, 2022

(54) SECURING DEVICE

(71) Applicant: SINOX CO., LTD., New Taipei City (TW)

(72) Inventor: Tun-Chuan HUANG, New Taipei City (TW)

(73) Assignee: SINOX CO., LTD., New Taipei City (TW)

(21) Appl. No.: 17/718,914

(22) Filed: Apr. 12, 2022

(30) Foreign Application Priority Data
Apr. 23, 2021 (TW) 110204579

(51) Int. Cl. E05B 37/02

(52) U.S. Cl. CPC E05B 37/02

(57) ABSTRACT

A securing device is provided. The securing device includes a body, a cover, a lock core, and a fastener. The cover is pivotally connected to the body. The cover is capable of rotating to a closed position or an open position with respect to the body. The lock core is disposed in the body or on the cover. When the lock core is in a locked state, at least a portion of the fastener is capable of inserting into the body from a side of the body, and the lock core restricts the fastener from leaving the body.

### BACKGROUND

### Field of the Invention

The present invention generally relates to a securing device. More particularly, the present invention relates to a clamshell type securing device which is capable of locking an object.

### Related Art

In public places such as a market, campus, station, gym, etc., in order to display bikes or park bikes temporarily, a lock would be used to prevent stealing or taking the bike by mistake.

Bike locks commonly used in the above-mentioned public places include key locks and combination locks connected with cables such as ropes, chains, etc. These locks are not convenient to use since the connecting and the disconnecting of the cables must be linked with the locking and the unlocking of a lock core.

### SUMMARY OF THE INVENTION

The object of the present invention is to provide a securing device which is more convenient to use to resolve the issues of the prior arts.

The securing device includes a body, a cover, a lock core, and a fastener. The cover is pivotally connected to the body. The cover is capable of rotating to a closed position or an open position with respect to the body. The lock core is disposed in the body or on the cover. When the lock core is in a locked state, at least a portion of the fastener is capable of inserting into the body from a side of the body, and the lock core restricts the fastener from leaving the body.

In one embodiment, the body includes a body stopper, wherein the body stopper is capable of rotating with respect to the body. The fastener is capable of engaging with the body stopper when it inserts into the body. When the lock core is in the locked state, the lock core restricts the body stopper from rotating, hence keeping the body stopper and the fastener engaged with each other to restrict the fastener from leaving the body.

In one embodiment, an X-axis, a Y-axis, and a Z-axis are orthogonal. The body stopper is pivotally connected with the body and is capable of rotating along an X-Z plane. The fastener includes a restricting mechanism, wherein the portion of the fastener inserted into the body is capable of moving along the X-axis to make the restricting mechanism engage with an end of the body stopper.

In one embodiment, the body stopper restricts the fastener inserted into the body from leaving the body when the cover is in the closed position. The cover drives the body stopper to rotate and remove the restriction over the fastener leaving the body when the cover is in the open position.

In one embodiment, the body includes an engaging part. The cover includes an engaging piece. The engaging piece is capable of moving selectively in an engaged position or a free position. When the cover is in the closed position and the engaging piece moves to the engaged position, the engaging part and the engagement piece engage with each other to restrict the cover from moving from the closed position to the open position. When the engaging piece moves to the free position, the engaging between the engaging part and the engaging piece is released.

In one embodiment, the lock core is disposed on the cover and includes a core stopper. When the cover is in the closed position and the engaging piece moves to the engaged position, and the lock core is in the locked state, the core stopper restricts the engaging piece from moving from the engaged position to the free position, hence restricting the cover from moving from the closed position to the open position.

In one embodiment, the cover is capable of rotating along the X-Z plane. The engaging part is capable of moving along the X-axis to make the engaging piece engage with the engaging part.

In one embodiment, the body includes a first elastic piece disposed in the body. The first elastic piece provides an elastic force pushing the engaging piece to the engaging part.

In one embodiment, the lock core is disposed in the body and includes a core stopper. When the lock core is in the locked state, the core stopper restricts the body stopper from rotating, hence restricting the fastener inserted into the body from leaving the body.

In one embodiment, the body stopper and the cover rotate coaxially.

In one embodiment, the body includes a second elastic piece disposed in the body. The second elastic piece provides an elastic force pushing the fastener out of the body when the fastener inserts into the body.

### BRIEF DESCRIPTION OF THE DRAWINGS

FIGS. 1A and 1B are exploded views of an embodiment of the securing device of the present invention.

FIG. 2A is a perspective view of an embodiment of the securing device of the present invention.

FIG. 2B is a top view of an embodiment of the securing device of the present invention.

FIG. 2C is a perspective cross-section view of an embodiment of the AA′ line in FIG. 2B.

FIG. 2D is a perspective cross-section view of an embodiment of the AA′ line in FIG. 2B.

FIGS. 3A and 3B are perspective views of an embodiment of the securing device of the present invention showing the fastener inserts into the body.

FIG. 4 is a perspective view of an embodiment of the securing device of the present invention showing the engaging part moves along the X-axis to the free position and the hook part leaves the restricting hole.

FIG. 5 is a perspective view of an embodiment of the securing device of the present invention showing the body stopper is pushed by the cover to rotate and lift up when the cover lifts up.

FIG. 6 is a perspective view of an embodiment of the securing device of the present invention showing the lock core inclines when the lock core is in the locked state.

FIG. 7 is a perspective view of an embodiment of the securing device of the present invention showing the end portion of the core stopper engages with the convex portion of the engaging part.

FIGS. 8A and 8B are perspective views of different embodiment of the securing device of the present invention.

### DETAILED DESCRIPTION

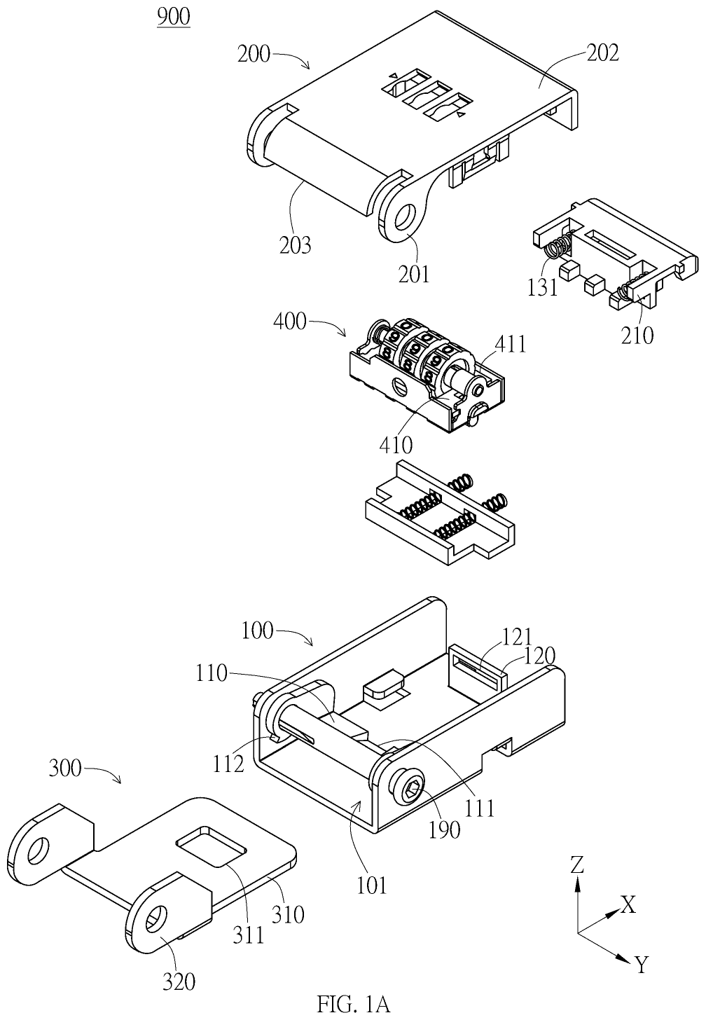

As shown in the embodiments in FIGS. 1A and 1B, the securing device 900 of the present invention includes a body 100, a cover 200, a fastener 300, and a lock core 400. The cover 200 is pivotally connected to the body 100. The cover 100 is capable of rotating to a closed position or an open position with respect to the body 100. The lock core 400 is disposed in the body 100 or on the cover 200. When the lock core 400 is in a locked state, at least a portion of the fastener 300 is capable of inserting into the body 100 from a side of the body 100, and the lock core 400 restricts the fastener 300 from leaving the body 100.

More particularly, in an embodiment, the body 100 includes a body stopper 110, wherein the body stopper 110 is capable of rotating with respect to the body 100. The body stopper 100 and the body 100 can be connected by a recovery unit such as a torsion spring to provide a recovery force, such as an elastic force, for the body stopper 110 to return to the position before the rotation after it is rotated. The cover 200 is pivotally connected to the body 100, wherein the cover is capable of rotating to the closed position or the open position with respect to the body 100. In an embodiment, an X-axis, a Y-axis, and a Z-axis are orthogonal. The cover 200 includes a pivot connecting part 201 and a plate part 202. The pivot connecting part 201 is pivotally connected to the body 100 via pivot 190. The plate part 202 is capable of rotating along an X-Z plane to cover the body 100 or to be lifted up.

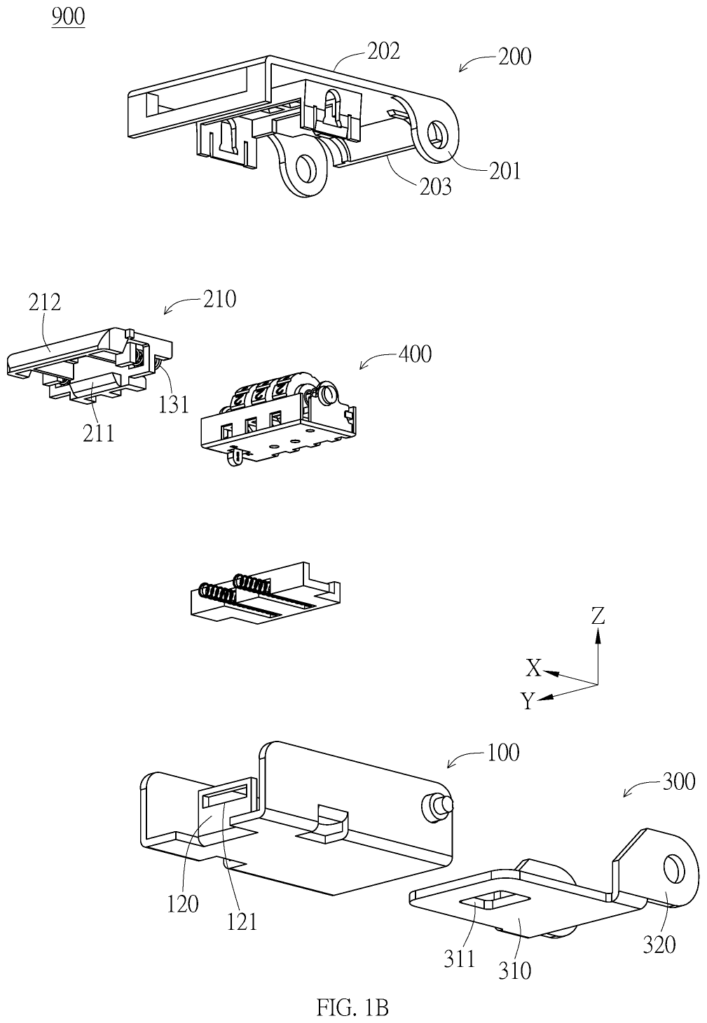

As shown in the embodiments in FIGS. 1A to 2D, at least a portion of the fastener 300 is capable of inserting into the body 100 from a side of the body 100 and engages with the body 100. When the lock core 400 is in the locked state, the lock core 400 restricts the body stopper 110 from rotating, hence keeps the body stopper 110 and the fastener 300 engaging with each other to restrict the fastener 300 from leaving the body 100. More particularly, in an embodiment, the body 100 and the fastener 300 connect respectively to the opposite ends of a cable (unshown) such as a rope, a chain, etc. In accordance with the above mentioned, the securing device 900 is capable of connecting and securing the opposite ends of the cable when the lock core 400 is in the locked state. Accordingly, it can be used as a bike lock. In different embodiments, the securing device 900 of the present invention can be used for locking objects which can be secured by cables. For example, it can be a fixing belt lock of a luggage case.

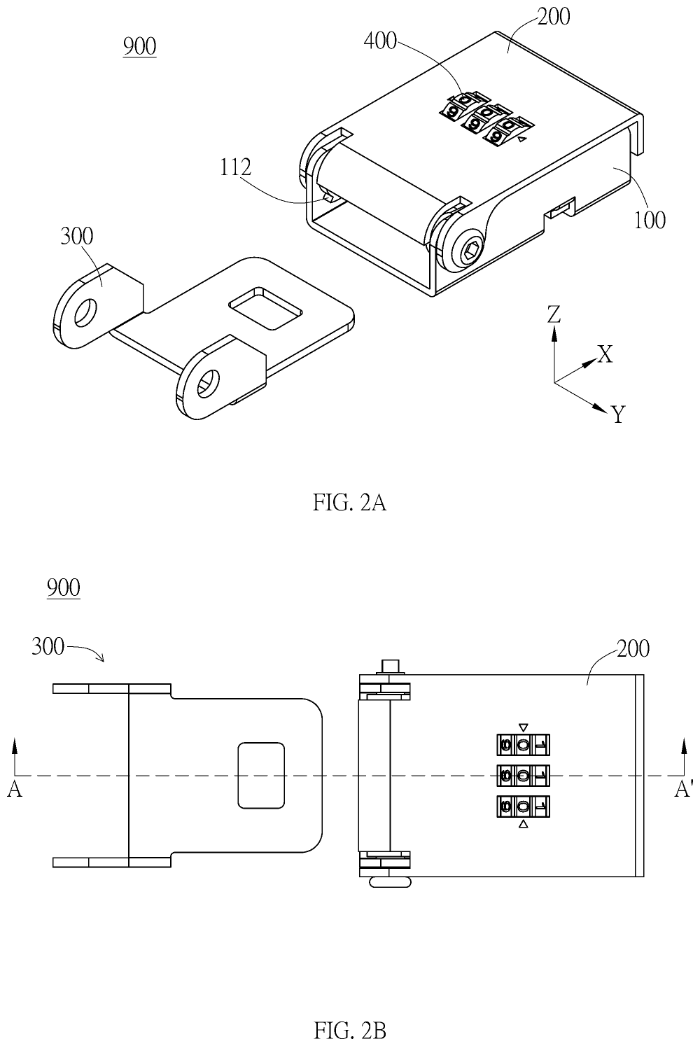

More particularly, as shown in the embodiments in FIGS. 2C and 2D, the X-axis, the Y-axis, and the Z-axis are orthogonal. The body stopper 110 is pivotally connected to the body 100 and is capable of rotating along the X-Z plane. The fastener 300 includes an inserting part 310 and a fastener connecting part 320. The inserting part 310 is capable of inserting into the body 100 from the body opening 101 along the X-axis. The inserting part 310 of the fastener 300 includes a restricting mechanism 311. The inserting part 310 is capable of moving along the X-axis after it inserts into the body 100, hence making the restricting mechanism 311 engage with an engaging end 111 of the body stopper 110. Specifically, the restricting mechanism 311 is a through hole. The inserting part 310 moves along the X-axis after it inserts into the body 100, wherein the portion of the inserting part 310 other than the restricting mechanism 311 engages with the body stopper 100 and pushes it to rotate along a direction 801. When the inserting part 310 arrives at the position shown in the embodiments in FIGS. 3A and 3B, the body stopper 110 rotates, along a direction 802, back to the position before the foregoing rotation, that is, the engaging end 111 inserts into and engages with the restricting mechanism 311.

In one embodiment, when the cover 200 is in the closed position, the body stopper 110 restricts the fastener 300 inserted into the body 100 from leaving the body 100. When the cover 200 is in the open position, the cover 200 drives the body stopper 110 to rotate and remove the restriction over the fastener 300 leaving the body 100. More particularly, the body 100 includes an engaging part 120. The cover 200 includes an engaging piece 210. The engaging piece 210 is capable of moving parallelly with the plate part 202 and selectively in an engaged position or a free position.

More particularly, as shown in the embodiments in FIGS. 3A and 3B, when the cover 200 is in the closed position and the engaging piece 210 moves to the engaged position, the engaging piece 210 and the engaging part 120 engage with each other to restrict the cover 200 from opening, i.e., to restrict the cover 200 from moving from the closed position to the open position. The engaging piece 210 includes a hook part 211 extending along the X-axis and a force applying part 212. The engaging part 120 is a plate disposed along an X-Y plane and having a restricting hole 121. The body 100 further includes a first elastic piece 131 disposed in the body 100. The first elastic piece 131 provides an elastic force pushing the engaging piece 210 to the engaging part 120. Accordingly, the hook part 211 is capable of inserting into the restricting hole 121, making the engaging piece 210 and the engaging part 120 engage with each other to restrict the cover 200 from rotating and opening along the direction 801.

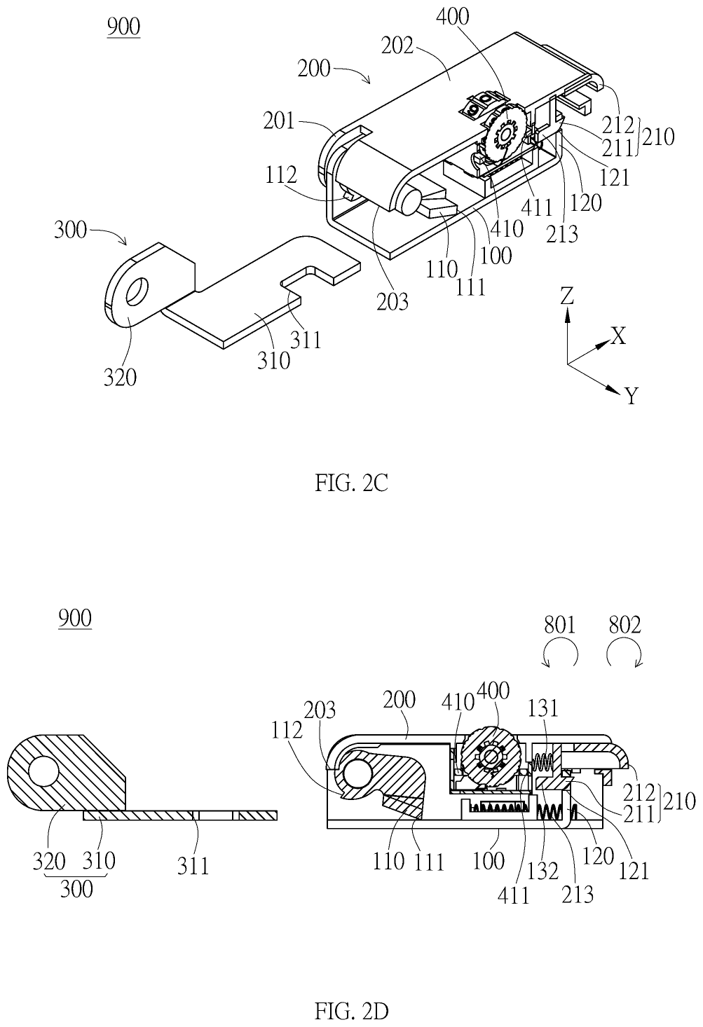

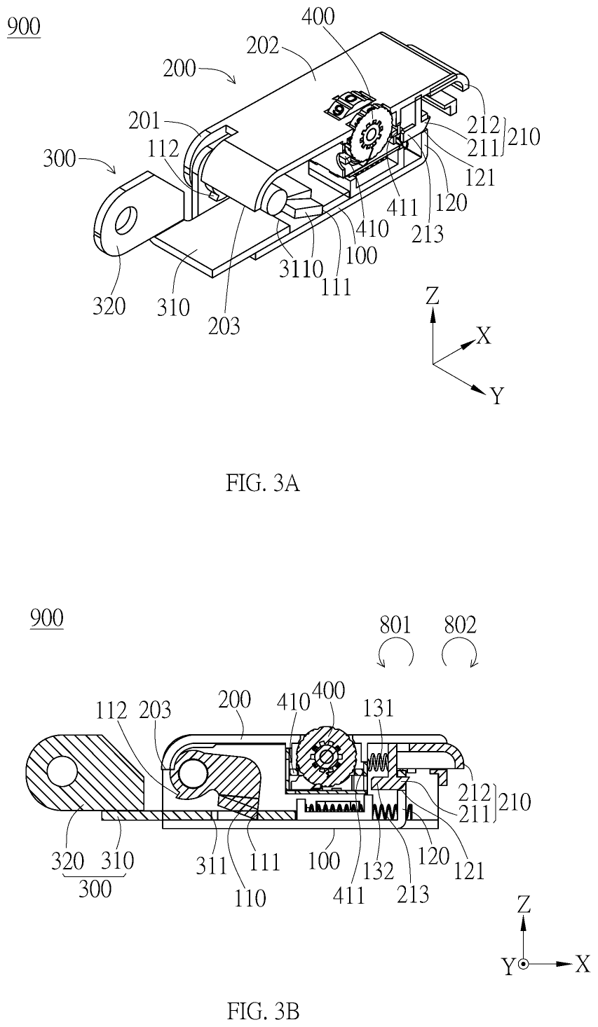

As shown in the embodiment in FIG. 4, when the lock core 400 is in an unlocked state, a user can apply a force to the force applying part 212 to push the engaging piece 210 to move along the X-axis to the free position. The hook part 211 leaves the restricting hole 121 and removes the engagement between the engaging piece 210 and the engaging part 120. After then, as shown in the embodiment in FIG. 5, the cover 200 is capable of rotating to the open position along the direction 801. The body stopper 110 and the cover 200 rotate coaxially. The body stopper 110 has a driving recess 112. When the cover 200 rotates to open along the direction 801, the end portion 203 of the cover 200 engages with the driving recess 112 and pushes the body stopper 110 to rotate and open along the direction 801, which makes the engaging end 111 leave the restricting mechanism 311 and hence remove the restriction over the fastener 300 leaving the body 100. At this time, the fastener 300 is capable of leaving the body 100. The body 100 further includes a second elastic piece 132 disposed in the body 100. The second elastic piece 132 provides an elastic force pushing the fastener 300 out of the body 100 when the fastener 300 inserts into the body 100. In other words, as shown in the embodiment in FIG. 4, the fastener 300 can be pushed out of the body 100 by the elastic force when the cover 200 rotates to open along the direction 801.

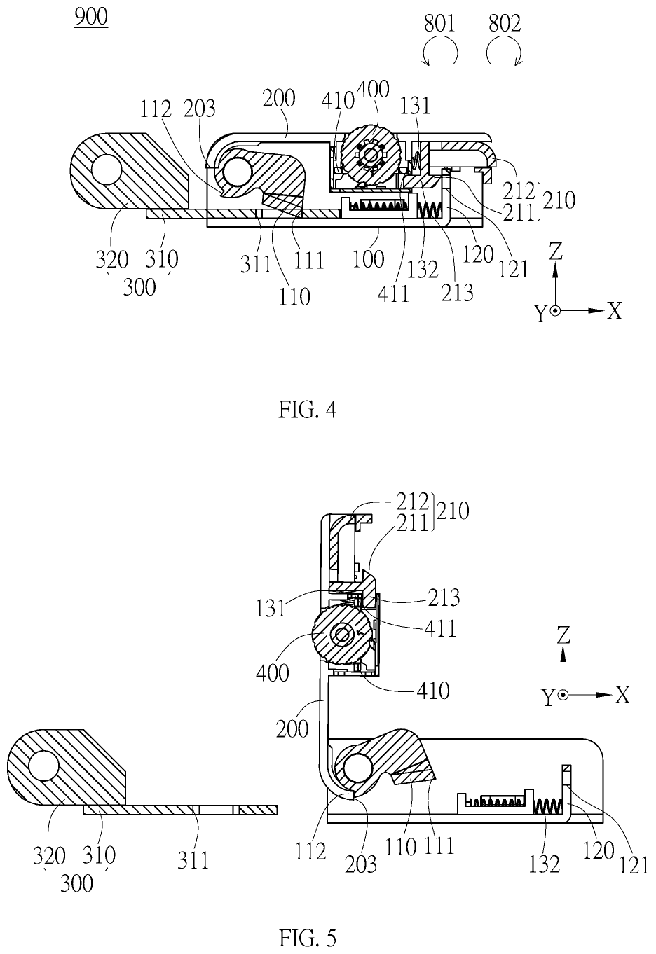

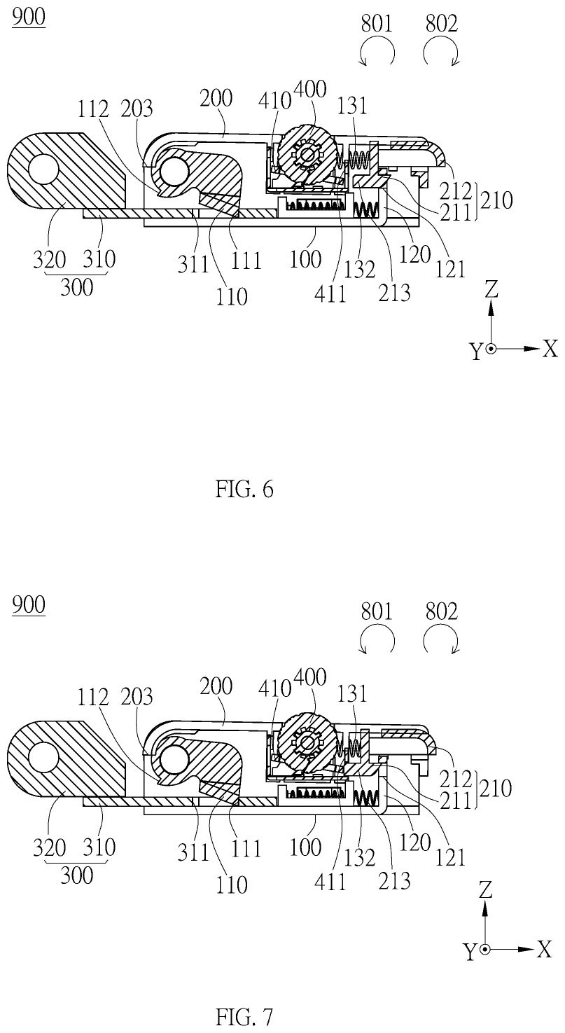

As shown in the embodiment in FIG. 6, the lock core 400 is disposed on the cover 200 and includes a core stopper 410. When the cover 200 is in the closed position and the engaging piece 210 moves to the engaged position and the lock core 400 is in the locked state, the core stopper 410 restricts the engaging piece 210 from moving from the engaged position to the free position (shown in FIG. 4), hence restricting the cover 200 from moving from the closed position to the open position. More particularly, in this embodiment, when the lock core 400 is in the locked state, the core stopper 410 is capable of inclining to make the end portion 411 on the moving path of the engaging piece 210. As shown in the embodiment in FIG. 7, when the user applies a force to the force applying part 212 to push the engaging piece 210 to move along the X-axis, the end portion 411 engages with the convex portion 213 of the engaging part 210 and restricts the engaging piece 210 from moving along the X-axis, hence keeping the engaging piece 210 and the engaging part 120 engaged with each other and restricting the cover 200 from opening. Accordingly, the body stopper 100 is restricted from rotating, and the body stopper 110 keeps engaging with the fastener 300 to restrict the fastener 300 from leaving the body 100. In other words, in this embodiment, when the lock core 400 is in the locked state, the cover 200 can't be opened to allow the fastener 300 to leave the body 100. The lock core 400 doesn't contact the body stopper 110 directly. The lock core 400 indirectly restricts the body stopper 110 from rotating.

Accordingly, when using the securing device 900 of the present invention, whether the lock core 400 is in the locked state or in the unlocked state, the fastener 300 is capable of inserting into and being secured by the body 100 to make the opposite ends of the cable connected to the securing device 900 connect with each other as a continuous piece and be hung on an object. When the lock core 400 is in the unlocked state, the connection of the cable can be broken by merely opening the cover 200. Therefore, it is more convenient to use.

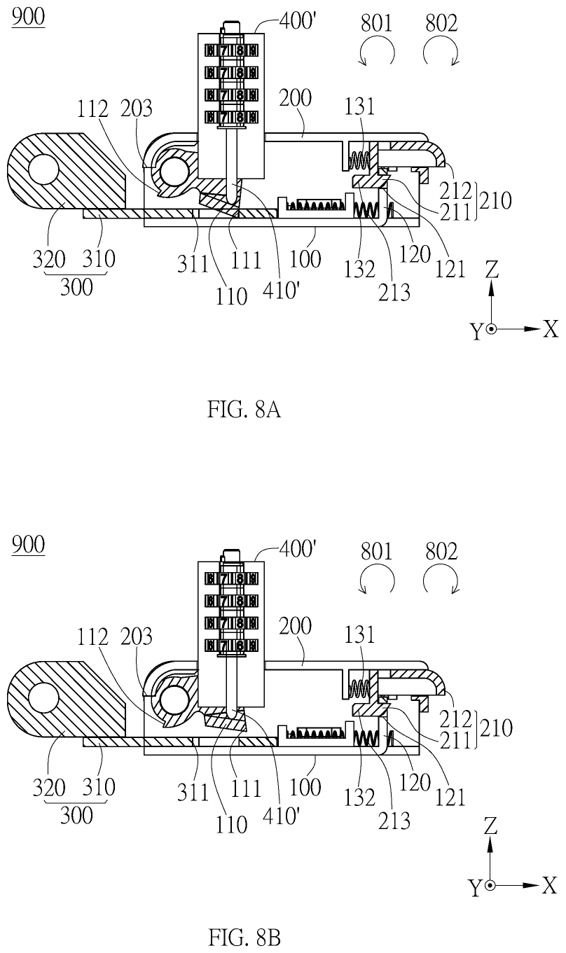

The type and location of the lock core may vary in different embodiments according to manufacturing, design, or use requirements. As shown in the embodiment in FIG. 8A, the lock core 400′ is disposed in the body 100 and includes a core stopper 410′ such as a lock rod. When the lock core 400′ is in the locked state, the core stopper 410′ engages with the body stopper 110 and restricts the body stopper 110 from rotating, hence restricting the fastener 300 inserted into the body 100 from leaving the body 100. As shown in the embodiment in FIG. 8B, when the lock core 400′ is in the unlocked state, the core stopper 410′ doesn't engage with the body stopper 110 and restrict the body stopper 110 from rotating, hence restricting the fastener 300 inserted into the body 100 from leaving the body 100. The body stopper 110 can rotate via a recovery unit such as a torsion spring to make the engaging end 111 leave the restricting mechanism 311 and hence remove the restriction over the fastener 300 leaving the body 100. In other words, in this embodiment, when the lock core 400 is in the locked state, the lock core 400 can directly contact the body stopper 110 and directly restricts the body stopper 110 from rotating. Whether the cover is open is irrelevant to whether the fastener 300 is capable of leaving the body 100.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A securing device, comprising:
a body;
a cover pivotally connected to the body, wherein the cover is capable of rotating to a closed position or an open position with respect to the body;
a lock core disposed in the body or on the cover;
a fastener, wherein when the lock core is in a locked state, at least a portion of the fastener is capable of inserting into the body from a side of the body, and the lock core restricts the fastener from leaving the body.

2. The securing device according to claim 1, wherein:
the body includes a body stopper, wherein the body stopper is capable of rotating with respect to the body;
the fastener is capable of engaging with the body stopper when it inserts into the body;
when the lock core is in the locked state, the lock core restricts the body stopper from rotating, hence keeping the body stopper and the fastener engaged with each other to restrict the fastener from leaving the body.

3. The securing device according to claim 2, wherein:
an X-axis, a Y-axis, and a Z-axis are orthogonal, wherein the body stopper is pivotally connected with the body and is capable of rotating along an X-Z plane;
the fastener includes a restricting mechanism, wherein the portion of the fastener inserted into the body is capable of moving along the X-axis to make the restricting mechanism engage with an end of the body stopper.

4. The securing device according to claim 3, wherein the body stopper restricts the fastener inserted into the body from leaving the body when the cover is in the closed position, wherein the cover drives the body stopper to rotate and remove the restriction over the fastener leaving the body when the cover is in the open position.

5. The securing device according to claim 4, wherein:
the body includes an engaging part;
the cover includes an engaging piece, wherein the engaging piece is capable of moving selectively in an engaged position or a free position, wherein the engaging part and the engaging piece engage with each other to restrict the cover from moving from the closed position to the open position when the cover is in the closed position and the engaging piece moves to the engaged position, wherein the engagement between the engaging part and the engaging piece is released when the engaging piece moves to the free position.

6. The securing device according to claim 5, wherein the lock core is disposed on the cover and includes a core stopper, wherein when the cover is in the closed position and the engaging piece moves to the engaged position and the lock core is in the locked state, the core stopper restricts the engaging piece from moving from the engaged position to the free position, hence restricting the cover from moving from the closed position to the open position.

7. The securing device according to claim 5, wherein the cover is capable of rotating along the X-Z plane, wherein the engaging part is capable of moving along the X-axis to make the engaging piece engage with the engaging part.

8. The securing device according to claim 5, wherein the body includes a first elastic piece disposed in the body, wherein the first elastic piece provides an elastic force pushing the engaging piece to the engaging part.

9. The securing device according to claim 2, wherein the lock core is disposed in the body and includes a core stopper, wherein when the lock core is in the locked state, the core stopper restricts the body stopper from rotating, hence restricting the fastener inserted into the body from leaving the body.

10. The securing device according to claim 1, wherein the body includes a second elastic piece disposed in the body, wherein the second elastic piece provides an elastic force pushing the fastener out of the body when the fastener inserts into the body.
